(19) United States
(12) Patent Application Publication
(10) Pub. No.: US 2010/0185370 A1
(43) Pub. Date: Jul. 22, 2010

(54) METHOD FOR CONTROLLING AN AUTOMATIC MULTI-STEP REDUCTION GEAR

(75) Inventors: Maik Wurthner, Friedrichshafen (DE); Werner Wolfgang, Ravensburg (DE); Ingo Sauter, Meckenbeuren (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/667,268

(22) PCT Filed: Jun. 19, 2008
(86) PCT No.: PCT/EP08/57751

§ 371 Date: Dec. 30, 2009

(30) Foreign Application Priority Data
Jul. 6, 2007 (DE) 10 2007 031 725.7

(51) Int. Cl. G06F 19/00

(52) U.S. Cl. 701/61

(57) ABSTRACT

The invention concerns a method for controlling an automated multi-step change-speed transmission of a motor vehicle, which is connected on the input side via at least one controllable friction clutch to a drive motor in the form of an internal combustion engine, and on the output side via an axle drive to the drive wheels of a driven axle, and which comprises a plurality of starting gears (G_{Anf}, G1-G5), such that at the beginning of a starting process one of the starting gears (G_{Anf}, G1-G5) is selected as a function of the vehicle's mass (m_{Fzg}) and of the road gradient (α_{Fb}) as the optimum starting gear (G_{Anf}_{_{—}}ₒₚₜ) and is then engaged. To avoid substantial implementation effort and cost, it is provided that after the specification of a minimum starting acceleration (a_{Anf}_{_{—}}ₘᵢₙ) and of a static engine torque (M_{Mot}_{_{—}}ₛₜ) transmitted, averaged over time, by the friction clutch during its slipping phase, a minimum transmission ratio (i_{Anf}_{_{—}}ₘᵢₙ) necessary for starting is calculated from the formula:

$${i}_{Anf\_min} = ( \begin{matrix}\frac{1}{2} * \frac{{M}_{Mot\_st} * {η}_{ges}}{{J}_{Antr} * {a}_{Anf\_min}} - \\ \sqrt{\begin{matrix}\frac{1}{4} {( \frac{{M}_{Mot\_st} * {η}_{ges}}{{J}_{Antr} * {a}_{Anf\_min}} )}^{2} - \\ \frac{{m}_{Fzg} * {a}_{Anf\_min} + {F}_{W}}{{J}_{Antr} * {a}_{Anf\_min}}\end{matrix}}\end{matrix} ) * \frac{{r}_{dyn}}{{i}_{Ha}}$$

and the optimum starting gear (G_{Anf}_{_{—}}ₒₚₜ) is selected as a function of the calculated minimum transmission ratio (i_{Anf}_{_{—}}ₘᵢₙ).

This application is a National Stage completion of PCT/EP2008/057751 filed Jun. 19, 2008, which claims priority from German patent application serial no. 10 2007 031 725.7 filed Jul. 6, 2007.

### FIELD OF THE INVENTION

The invention concerns a method for controlling an automated multi-step change-speed transmission of a motor vehicle, which is connected on the input side to a drive motor in the form of an internal combustion engine via at least one controllable friction clutch, and on the output side to drive wheels of a driven axle via an axle drive, and which comprises a plurality of starting gears, such that at the beginning of a starting process one of the starting gears is selected as the optimum starting gear as a function of the vehicle's mass and the gradient of the road, and is then engaged.

### BACKGROUND OF THE INVENTION

Automated multi-step change-speed transmissions with a plurality of starting gears are mainly used in utility vehicles of the medium and heavy weight categories. They are preferably automated change-speed transmissions with a single input shaft that can be connected to the drive engine via a controllable friction clutch or, in the case of automated dual-clutch transmissions, with two input shafts that can be connected to the drive engine via a respective controllable friction clutch in each case. When the motor vehicle is started, the friction clutch associated with the selected starting gear is used as the starting clutch. When the starting gear selected has been engaged, the rotational speed difference between the drive engine and the input shaft concerned, which is large to begin with and decreases with increasing driving speed, is bridged by slipping operation of the starting clutch. Besides the vehicle's mass, the gradient of the road, the speed and the torque of the drive engine, the duration of the slipping operation and the quantity of heat generated thereby in the friction clutch are determined essentially by the transmission ratio of the starting gear and hence by the choice of the starting gear.

If too low a gear with too high a transmission ratio is used as the starting gear, then due to the large traction force on the wheels of the driven axle the shift speed of the drive engine is reached very quickly and an upshift consequently takes place, in some circumstances more than once and in rapid succession. Disadvantageously, these shift processes result in comfort-reducing interruptions or breaks of the traction force and in unnecessary wear of the gears and friction clutches and of the associated control drive mechanisms. On the other hand, if too high a gear with too low a transmission ratio is used as the starting gear, then owing to the low traction force on the wheels of the driven axle and the large rotation speed difference between the drive engine and the input shaft, slipping operation of the friction clutch is substantially prolonged, which besides delaying the starting process, can also lead to thermal overloading and damage of the friction clutch. In an extreme case, for example when trying to start with a heavy load on a steep hill, if too high a starting gear is used the traction force on the wheels of the driven axle can even be smaller than the overall driving resistance formed in such a case from the resistance due to the slope and the rolling resistance, so the motor vehicle will roll backward in an unsafe manner.

Whereas an experienced professional driver can certainly select the most suitable starting gear for the starting situation at the time, this is much more difficult for an inexperienced driver in particular because the road gradient and its influence on the starting process are difficult to estimate. Besides, for example in urban stop-and-go traffic, a driver may be distracted to a safety-relevant extent from observing what is going on in the traffic around him, by having to select the optimum starting gear each time.

Thus, to increase traffic safety, assist the driver, and extend the life of the motor vehicle, there is a need to automate the selection of the starting gear that is optimum on each occasion. With this in mind, a number of methods for the automated determination of a starting gear have already been proposed.

A first such method for determining a starting gear is known from U.S. Pat. No. 5,406,862 A. According to this known method it is provided that in a driving cycle prior to starting, the road gradient and the driving acceleration are determined by sensor means, for example by a gradient sensor fitted on the motor vehicle and a rotation speed sensor arranged on the output shaft of the multi-step change-speed transmission, from the road gradient and driving acceleration values determined the driving acceleration that can be reached on level ground with the same drive engine torque is calculated, and from the value of the driving acceleration on level ground the mass of the vehicle is calculated. Furthermore it is provided that from a vehicle-specific performance characteristic stored in a data memory of the transmission control unit and using the values of road gradient and vehicle mass, the optimum starting gear for the forthcoming starting process is determined, if necessary by interpolation and, if the current vehicle mass value is not available, using the value of the maximum vehicle mass.

Another such method for determining a starting gear is described in DE 198 39 837 A1. According to this known method it is provided that at the beginning of a starting process maximum admissible values of the slipping time and/or the frictional work of the starting clutch during the starting process, and the drive engine torque available, are determined. Then, in a calculation loop that begins with the highest starting gear, the values of the respective slipping time and/or frictional work of the starting clutch to be expected using the starting gear are calculated in advance, these values are compared with the maximum admissible values, and this is repeated for the next-lower starting gear in each case until the pre-calculated values become smaller than or equal to the maximum admissible values. The highest starting gear whose pre-calculated values do not exceed the maximum admissible values is then the optimum starting gear sought. Since determining the maximum admissible slipping time and/or frictional work of the starting clutch is very complicated and cannot be calculated quickly if the effort of doing so is kept within acceptable limits, a vehicle-specific performance characteristic stored in a data memory of the transmission control unit is provided, at least for this purpose.

Thus, the common feature of the known control methods is that to determine the optimum starting gear, in each case vehicle-specific performance characteristics are needed. During vehicle development these performance characteristics have to be determined or adapted individually for each combination of motor vehicle, drive engine, multi-step change-speed transmission and driven axle, which entails a great deal of work that must be carried out by appropriately trained technical personnel. Furthermore, in these methods there is a risk that performance characteristics pertaining to a multi-step change-speed transmission used in different vehicle applications and/or available in other versions and therefore appropriate for some other vehicle configuration or transmission variant, may inadvertently be stored in the data memory of the transmission control unit.

### SUMMARY OF THE INVENTION

Against that background the purpose of the present invention is to propose a method for controlling an automated multi-step change-speed transmission of the type mentioned at the start, using which the optimum starting gear can be determined simply and reliably without having to make use of vehicle-specific performance characteristics whose determination is elaborate and costly.

This objective is achieved by the characteristics specified in the main claim. According to this, the invention starts from a method for controlling an automated multi-step change-speed transmission of a motor vehicle, connected on the input side via at least one controllable friction clutch to a drive motor in the form of an internal combustion engine and on the output side, via an axle drive, to drive wheels of a driven axle, and which comprises a plurality of starting gears, such that at the beginning of a starting process one of the starting gears is selected as a function of the vehicle's mass m_{Fzg} and of the road gradient α_{Fb} as the optimum starting gear G_{Anf}_{_{—}}ₒₚₜ, and is then engaged.

Furthermore, in the method according to the invention it is provided that after specification of a minimum starting acceleration a_{Anf}_{_{—}}ₘᵢₙ and of a static engine torque M_{Mot}_{_{—}}ₛₜ transmitted, time-averaged, over the duration of the slipping phase of the friction clutch, a minimum transmission ratio i_{Anf}_{_{—}}ₘᵢₙ necessary for starting is calculated in accordance with the formula:

$${i}_{Anf\_min} = ( \begin{matrix}\frac{1}{2} * \frac{{M}_{Mot\_st} * {η}_{ges}}{{J}_{Antr} * {a}_{Anf\_min}} - \\ \sqrt{\begin{matrix}\frac{1}{4} {( \frac{{M}_{Mot\_st} * {η}_{ges}}{{J}_{Antr} * {a}_{Anf\_min}} )}^{2} - \\ \frac{{m}_{Fzg} * {a}_{Anf\_min} = {F}_{W}}{{J}_{Antr} * {a}_{Anf\_min}}\end{matrix}}\end{matrix} ) * \frac{{r}_{dyn}}{{i}_{Ha}}$$

in which η_{ges} is the overall efficiency of the motor vehicle, J_{Antr} is the mass moment of inertia of the rotating components of the motor vehicle, F_{W} is the driving resistance of the motor vehicle, r_{dyn} is the dynamic tire radius of the wheels on the driven axle, and i_{Ha} is the transmission ratio of the axle drive of the driven axle, and the optimum starting gear G_{Anf}_{_{—}}ₒₚₜ is selected as a function of the minimum transmission ratio i_{Anf}_{_{—}}ₘᵢₙ so calculated.

Advantageous and expedient design features and further development of the method according to the invention are the object of the subordinate claims.

In contrast to the known methods for determining a starting gear, which rely on vehicle-specific performance characteristics, in the method according to the present invention known or appropriately specified parameters are used to calculate directly the minimum starting transmission ratio i_{Anf}_{_{—}}ₘᵢₙ required in order to start under the starting conditions at the time, in particular the current vehicle mass m_{Fzg} and the current road gradient α_{Fb}, and hence, from the starting gears G_{Anf} available, the optimum starting gear G_{Anf}_{_{—}}ₒₚₜ is selected.

Although the most accurate possible determinations of the vehicle's mass m_{Fzg} and the road gradient α_{Fb} are certainly required for the application of the method according to the invention, they are not, however, directly objects of the method as such. Rather, the starting point for using the method according to the invention is a sufficiently accurate determination of these parameters in advance, or when beginning to use the method. Appropriate methods for determining vehicle mass m_{Fzg} are known, for example from EP 0 666 435 B1, DE 198 37 380 A1 and DE 10 2004 015 966 A1. Similarly, the road gradient α_{Fb} can be calculated at the end of the previous driving cycle from the driving resistance F_{W} and the engine torque M_{Mot}, or determined at the time by means of a gradient sensor fitted in the motor vehicle or by means of a navigation system from a road databank containing information about the road gradient α_{Fb}.

The formula indicated for calculating the minimum starting acceleration a_{Anf}_{_{—}}ₘᵢₙ can be derived from the driving resistance equation known per se:

F_{Zug}=F_{W}+F_{Träg}+F_{Teta}

in which F_{Zug} is the traction force transmitted from the drive engine to the drive wheels of the driven axle, F_{Träg} is the translational inertial resistance of the vehicle's mass m_{Fzg}, and F_{Teta} is the rotational inertial resistance due to the mass moment of inertia J_{Antr} of the rotating components of the motor vehicle. With the relationships known per se for:

$${F}_{Zug} = {M}_{Mot\_st} * \frac{{i}_{Ha}}{{r}_{dyn}} * {i}_{G} * {η}_{ges} , \\ {F}_{Tr \ddot{a} g} = {m}_{Fzg} * {a}_{Fzg} , and$$

$${F}_{Teta} = {J}_{Antr} * {a}_{Fzg} * {( \frac{{i}_{Ha}}{{r}_{dyn}} * {i}_{G} )}^{2} ,$$

in which, throughout, i_{G} is the transmission ratio of the gear engaged in the multi-step change-speed transmission and a_{Fzg} is the acceleration of the vehicle, insertion and transposition yield the quadratic equation:

$$0 = A * {i}_{G}^{2} + B * {i}_{G} + C , \\ with$$

$$A = {J}_{Antr} * {a}_{Fzg} * {( \frac{{i}_{Ha}}{{r}_{dyn}} )}^{2} , \\ B = - {M}_{Mot\_st} * \frac{{i}_{Ha}}{{r}_{dyn}} * {η}_{ges} , and$$

$$C = {m}_{Fzg} * {a}_{Fzg} + {F}_{W} .$$

In a manner known per se this equation can be solved to obtain:

$${i}_{G} = - \frac{1}{2} * \frac{B}{A} ( + ) / - \sqrt{\frac{1}{4} {( \frac{B}{A} )}^{2} - \frac{C}{A}} ,$$

and for plausibility reasons only the smaller solution is taken to yield a realistic result. By inserting the minimum starting acceleration a_{Anf}_{_{—}}ₘᵢₙ to be specified in place of the vehicle's acceleration a_{Fzg}, this formula becomes identical to the solution formula given above and yields the minimum transmission ratio i_{Anf}_{_{—}}ₘᵢₙ required for starting, which, according to the invention, is used for determining the optimum starting gear G_{Anf}_{_{—}}ₒₚₜ.

Since because of the low driving speed v_{Fzg} the air resistance F_{Luft} is negligible, the driving resistance F_{W} consists of the sum of the rolling resistance F_{Roll} and the gradient resistance F_{Steig} and can be calculated from the equation:

F_{w}=m_{Fzg}*g*(f_{Roll}*cos(α_{Fb})+sin(α_{Fb}))

in which g is the acceleration due to gravity, f_{Roll} is the rolling resistance factor and α_{Fb} is the gradient angle of the road.

The optimum starting gear G_{Anf}_{_{—}}ₒₚₜ can be determined in such manner that the starting gear G_{Anf} selected as the optimum starting gear G_{Anf}_{_{—}}ₒₚₜ is the one whose transmission ratio i_{G}_{_{—}}_{Anf} is higher than or equal to the calculated minimum transmission ratio i_{Anf}_{_{—}}ₘᵢₙ (i_{G}_{_{—}}_{Anf}≦i_{Anf}_{_{—}}ₘᵢₙ). In this way, starting in too high a starting gear G_{Anf} with too low a transmission ratio is reliably avoided.

Alternatively however, the optimum starting gear G_{Anf}_{_{—}}ₒₚₜ can be determined by selecting as the optimum starting gear G_{Anf}_{_{—}}ₒₚₜ that starting gear G_{Anf} whose transmission ratio i_{G}_{_{—}}_{Anf} is closest to the calculated minimum transmission ratio i_{Anf}_{_{—}}ₘᵢₙ (i_{G}_{_{—}}_{Anf}≈i_{Anf}_{_{—}}ₘᵢₙ). This avoids the possibility of ignoring a nearby starting gear G_{Anf} with a transmission ratio i_{G}_{_{—}}_{Anf} just slightly lower than the calculated minimum transmission ratio i_{Anf}_{_{—}}ₘᵢₙ, and instead using the next-lower starting gear G_{Anf} with an unnecessarily high transmission ratio i_{G}_{_{—}}_{Anf}.

With a view to an operationally most favorable possible determination of the optimum starting gear G_{Anf}_{_{—}}ₒₚₜ, however, it is particularly advantageous to specify a tolerance limit δ above and below the calculated minimum transmission ratio i_{Anf}_{_{—}}ₘᵢₙ and, when there is at least one starting gear G_{Anf} whose transmission ratio i_{G}_{_{—}}_{Anf} is within the tolerance limits, to select as the optimum starting gear G_{Anf}_{_{—}}ₒₚₜ that starting gear G_{Anf} whose transmission ratio i_{G}_{_{—}}_{Anf} is closest to the calculated minimum transmission ratio i_{Anf}_{_{—}}ₘᵢₙ (i_{G}_{_{—}}_{Anf}≈i_{Anf}_{_{—}}ₘᵢₙ), whereas if there is no starting gear Gₐₙₜ whose transmission ratio i_{G}_{_{—}}_{Anf} is within the tolerance limits δ, to select as the optimum starting gear G_{Anf}_{_{—}}ₒₚₜ the next-lower starting gear G_{Anf}, whose transmission ratio i_{G}_{_{—}}_{Anf} is higher than the calculated minimum transmission ratio i_{Anf}_{_{—}}ₘᵢₙ (i_{G}_{_{—}}_{Anf}>i_{Anf}_{_{—}}ₘᵢₙ).

In practice it has been found appropriate to specify the tolerance limits δ for selecting the optimum starting gear G_{Anf}_{_{—}}ₒₚₜ as ±5% relative to the calculated minimum transmission ratio i_{Anf}_{_{—}}ₘᵢₙ (δ=i_{Anf}_{_{—}}ₘᵢₙ±5%).

However, if there exists a starting gear restriction, then in the event of selecting a gear Gᵢ that is higher than the highest admissible starting gear G_{Anf}_{_{—}}ₘₐₓ, under all circumstances the highest admissible starting gear G_{Anf}_{_{—}}ₘₐₓ is used as the optimum starting gear G_{Anf}_{_{—}}ₒₚₜ (G_{Anf}_{_{—}}ₒₚₜ=G_{Anf}_{_{—}}ₘₐₓ).

The static engine torque M_{Mot}_{_{—}}ₛₜ to be specified is expediently calculated by multiplying the nominal torque M_{Mot}_{_{—}}_{Ref} of the drive engine by a starting factor f_{Anf}<1. This takes into account that it is not necessary always to start with the maximum torque of the drive engine, and that the time-averaged torque transmitted by the friction clutch during its slipping phase is below the value at the end of the slipping phase.

The starting factor f_{Anf} can be specified as a constant independent of the vehicle's mass m_{Fzg} and the road gradient α_{Fb}, and a value f_{Anf}=0.5 has been found to be appropriate.

It is also possible, however, to calculate the starting factor f_{Anf} as a variable that depends on the vehicle's mass m_{Fzg} and/or on the road gradient α_{Fb}. This can for example be done in such manner that starting from a standard value f_{Anf}_{_{—}}_{Std} valid for an average vehicle mass m_{Fzg}_{_{—}}ₘ and/or an average road gradient α_{Fb}_{_{—}}ₘ, the starting factor f_{Anf} is reduced with decreasing vehicle mass m_{Fzg} and increased with increasing vehicle mass m_{Fzg}, and/or reduced with decreasing road gradient α_{Fb} and increased with increasing road gradient α_{Fb}. The result of this is that when the vehicle's mass m_{Fzg} is low, i.e. the vehicle is not heavily loaded, and/or when the road gradient α_{Fb} is small, a starting gear G_{Anf} is selected which enables starting with a lower engine power, whereas when the vehicle's mass m_{Fzg} is high, i.e. when it is heavily loaded, and/or when the road gradient α_{Fb} is large, a starting gear G_{Anf} is selected which enables starting with a higher engine power.

The minimum starting acceleration a_{Anf}_{_{—}}ₘᵢₙ can also be specified as a constant independent of the vehicle's mass m_{Fzg} and the road gradient α_{Fb}, and a value of a_{Anf}_{_{—}}ₘᵢₙ=0.2 m/s² is regarded as appropriate.

Alternatively, however the minimum starting acceleration a_{Anf}_{_{—}}ₘᵢₙ can also be calculated as a variable that depends on the vehicle's mass M_{Fzg} and/or on the road gradient α_{Fb}. This can for example be done in such manner that starting from a standard value a_{Anf}_{_{—}}_{Std} valid for an average vehicle mass M_{Fzg}_{_{—}}ₘ and/or an average road gradient α_{Fb}_{_{—}}ₘ, the minimum starting acceleration a_{Anf}_{_{—}}ₘᵢₙ increases with decreasing vehicle mass m_{Fzg} and decreases with increasing vehicle mass m_{Fzg}, and/or increases with decreasing road gradient α_{Fb} and decreases with increasing road gradient α_{Fb}. The result of this is that when the vehicle's mass M_{Fzg} is low, i.e. when the vehicle is not heavily loaded, and/or when the road gradient α_{Fb} is small, a starting gear G_{Anf} is selected which enables starting with a higher starting acceleration a_{Anf}, whereas when the vehicle's mass m_{Fzg} is high, i.e. when it is heavily loaded, and/or when the road gradient α_{Fb} is large, a starting gear G_{Anf} is selected which enables starting with a lower starting acceleration a_{Anf}.

### BRIEF DESCRIPTION OF THE DRAWINGS

To clarify the invention the description of a drawing is given below. The drawing shows:

FIG. 1: Diagram showing values of the minimum starting acceleration calculated as a function of several vehicle masses m_{Fzg} for a range of road gradients α_{Fb} or Stg; and

FIG. 2: Diagram showing values of the minimum starting acceleration calculated for a vehicle mass m_{Fzg} of 40 tons (=40000 kg), for a range of road gradients α_{Fb} or Stg, when a tolerance range has been specified.

### DETAILED DESCRIPTION OF THE PREFERRED EMBODIMENTS

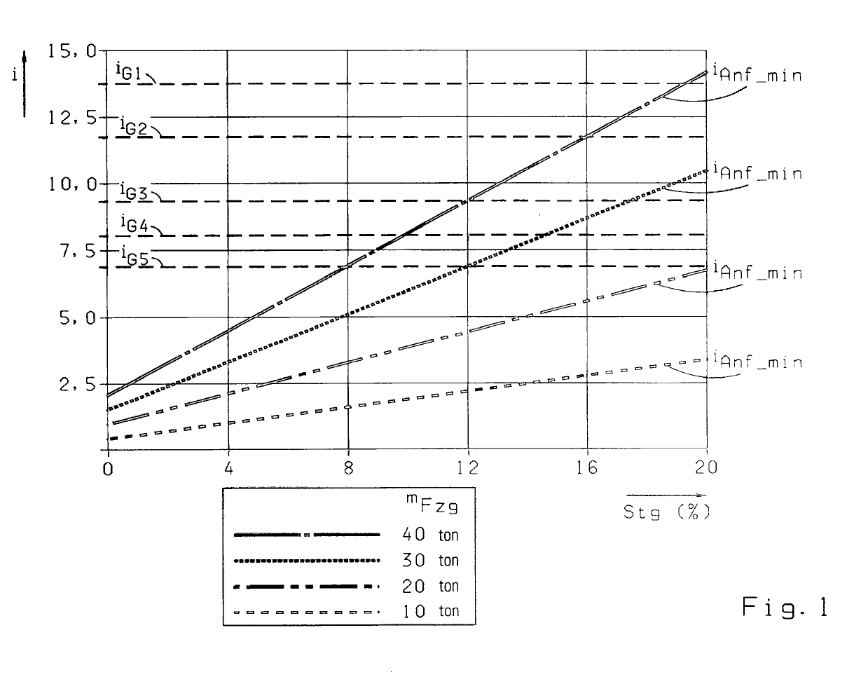

In the diagram of FIG. 1, for vehicle masses M_{Fzg} of 10, 20, 30 and 40 tons, the values of the minimum transmission ratio i_{Anf}_{_{—}}ₘᵢₙ required for starting, calculated using the formula given in claim 1 in each case in the range of road gradients Stg from 0% to 20% (corresponding, with α_{Fb}=arctan(Stg/100), to a gradient angle α_{Fb} of 0° to 11.31°), are shown. The calculations were carried out using the following values:

### M_{Mot}_{_{—}}_{Ref}=2000 Nm

f_{Anf}=0.5
i_{Ha}=3.7
r_{dyn}=0.522 m
η_{ges}=0.98
J_{Antr}=3.8 kg m²
f_{Roll}=0.015
a_{Anf}_{_{—}}ₘᵢₙ=0.2 m/s²
G_{Anf}_{_{—}}ₘₐₓ=G5 (5th gear)

In addition, the horizontal broken lines in the diagram of FIG. 1 show, as examples with i_{G1}=13.68, i_{G2}=11.64, i_{G3}=9.4, i_{G4}=8.0 and i_{G5}=6.73, the transmission ratios of the gears G1 to G5 provided in this case as starting gears G_{Anf}.

From this it emerges, for example, that with a vehicle mass of m_{Fzg}=40 tons and a road gradient of Stg=10%, for which a minimum transmission ratio of i_{Anf}_{_{—}}ₘᵢₙ=7.96 is calculated, regardless of whether, in relation to its transmission ratio i_{G}_{_{—}}_{Anf} the next-higher or lower starting gear G_{Anf} is selected as the optimum starting gear G_{Anf}_{_{—}}ₒₚₜ, in each case the fourth gear G4 with transmission ratio i_{G4}=8.0 is determined as the starting gear G_{Anf}_{_{—}}ₒₚₜ (G_{Anf}_{_{—}}ₒₚₜ=G4).

In contrast, with a vehicle mass of m_{Fzg}=40 tons and a road gradient of Stg=14%, for which a minimum transmission ratio of i_{Anf}_{_{—}}ₘᵢₙ=10.42 is calculated, if a starting gear G_{Anf} selected in relation to its transmission ratio i_{G}_{_{—}}_{Anf} as closest is chosen as the optimum starting gear G_{Anf}_{_{—}}ₒₚₜ, the choice determined will be the third gear G3 with transmission ratio i_{G3}=9.4 (G_{Anf}_{_{—}}ₒₚₜ=G3), whereas if a starting gear G_{Anf} is selected in relation to its transmission ratio i_{G}_{_{—}}_{Anf} as lower, then the second gear G2 with transmission ratio i_{G2}=11.64 will be chosen as the optimum starting gear G_{Arf}_{_{—}}ₒₚₜ (G_{Anf}_{_{—}}ₒₚₜ=G2).

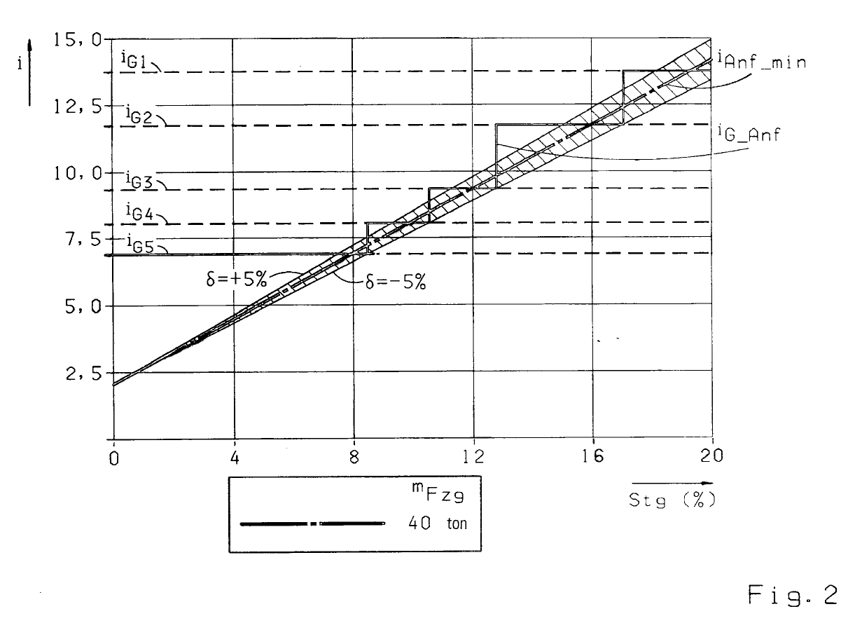

In an advantageous further development of the method according to the invention, as illustrated in the diagram of FIG. 2 for a vehicle mass m_{Fzg}=40 tons by the hatched tolerance range, upper and lower tolerance limits of δ=±5% in the present case relative to the calculated minimum transmission ratio i_{Anf}_{_{—}}ₘᵢₙ are specified. If, at the operating point concerned, at least one starting gear G1 to G5 has a transmission ratio i_{G1} to i_{G5} that lies within the tolerance limits δ, then that starting gear G1 to G5 whose transmission ratio i_{G1} to i_{G5} is closest to the calculated minimum transmission ratio i_{Anf}_{_{—}}ₘᵢₙ is selected at the optimum starting gear G_{Anf}_{_{—}}ₒₚₜ.

On the other hand, if none of the starting gears G1 to G5 has a transmission ratio i_{G1} to i_{G5} that lies within the tolerance limits δ, then the closest lower starting gear G1 to G5 whose transmission ratio i_{G1} to i_{G5} is higher than the calculated minimum transmission ratio i_{Anf}_{_{—}}ₘᵢₙ is selected as the optimum starting gear G_{Anf}_{_{—}}ₒₚₜ.

The resulting, stepped decision-limit line is shown in FIG. 2 as a heavy continuous line indexed i_{G}_{_{—}}_{Anf}. From this representation it can be seen that in the present application example, up to a road gradient of Stg=8.6% (giving a calculated minimum transmission ratio of i_{Anf}_{_{—}}ₘᵢₙ=7.11) the fifth gear G5 is selected as the starting gear, above this gradient value up to a gradient of Stg=10.77% (corresponding to a calculated minimum transmission ratio of i_{Anf}_{_{—}}ₘᵢₙ=8.43) the fourth gear G4 is selected as the starting gear, above this gradient value up to a gradient of Stg=13.23% (giving i_{Anf}_{_{—}}ₘᵢₙ=9.94) the third gear G3 is selected as the starting gear, above this gradient value up to a gradient of Stg=16.99% (giving i_{Anf}_{_{—}}ₘᵢₙ=12.27%) the second gear G2 is selected as the starting gear, and above a gradient of Stg=16.99% the first gear G1 is used as the starting gear.

Indexes

| | |
|---|---|
| a_{Anf}_{_{—}}ₘᵢₙ | Minimum starting acceleration |
| a_{Anf}_{_{—}}_{Std} | Standard value of the starting acceleration |
| a_{Fzg} | Acceleration of the vehicle (in general) |
| f_{Anf} | Starting factor |
| f_{Anf}_{_{—}}_{Std} | Standard value of the starting factor |
| f_{Roll} | Rolling resistance factor |
| F_{Luft} | Air resistance |
| F_{Roll} | Rolling resistance |
| F_{Steig} | Gradient resistance |
| F_{Teta} | Inertial resistance of the rotating masses |
| F_{Träg} | Inertial resistance of the vehicle's mass |
| F_{W} | Driving resistance |
| F_{Zug} | Traction force (on the wheels of the driven axle) |
| g | Gravitational acceleration |
| G_{Anf} | Starting gear (in general) |
| G_{Anf}_{_{—}}ₘₐₓ | Highest admissible starting gear |
| G_{Anf}_{_{—}}ₒₚₜ | Optimum starting gear |
| Gᵢ | Gear (in general) |
| G1 | First gear |
| G2 | Second gear |
| G3 | Third gear |
| G4 | Fourth gear |
| G5 | Fifth gear |
| i_{Anf}_{_{—}}ₘᵢₙ | Minimum transmission ratio (of the multi-step change-speed |
| | transmission) |
| i_{G} | Transmission ratio of the gear engaged (in general) |
| i_{G}_{_{—}}_{Anf} | Transmission ratio of the starting gear (in general) |
| i_{Ha} | Transmission ratio of the driven axle (rear axle) |
| i_{G1} | Transmission ratio of G1 |
| i_{G2} | Transmission ratio of G2 |
| i_{G3} | Transmission ratio of G3 |
| i_{G4} | Transmission ratio of G4 |
| i_{G5} | Transmission ratio of G5 |
| J_{Antr} | Mass moment of inertia of the motor vehicle |
| m_{Fzg} | Mass of the vehicle |
| m_{Fzg}_{_{—}}ₘ | Average vehicle mass |
| M_{Mot}_{_{—}}_{Ref} | Normal drive engine torque |
| M_{Mot}_{_{—}}ₛₜ | Static drive engine torque |
| r_{dyn} | Dynamic tire radius (of the wheels on the driven axle) |
| Stg | Road gradient (in %) |
| α_{Fb} | Road gradient (in °) |
| α_{Fb}_{_{—}}ₘ | Average road gradient (in °) |
| δ | Tolerance limit |
| η_{ges} | Overall efficiency of the drivetrain |

1-15. (canceled)

16. A method of controlling an automated multi-step change-speed transmission of a motor vehicle, which is connected on an input side, via at least one controllable friction clutch, to a drive motor and on an output side, via an axle drive, to drive wheels of a driven axle, and which comprises a plurality of starting gears (G_{Anf}, G1-G5) such that upon beginning of a starting process one of the starting gears (G_{Anf}, G1-G5) is selected, as a function of a vehicle mass (m_{Fzg}) and of the road gradient (α_{Fb}), as the optimum starting gear (G_{Anf}_{_{—}}ₒₚₜ) and is then engaged, the method comprising the steps of:
specifying a minimum starting acceleration (a_{Anf}_{_{—}}ₘᵢₙ) and of a static engine torque (M_{Mot}_{_{—}}ₛₜ) transmitted, averaged over time, by the friction clutch during a slipping phase, calculating a minimum transmission ratio (i_{Anf}_{_{—}}ₘᵢₙ) necessary for starting from the formula:
$${i}_{Anf\_min} = ( \begin{matrix}\frac{1}{2} * \frac{{M}_{Mot\_st} * {η}_{ges}}{{J}_{Antr} * {a}_{Anf\_min}} - \\ \sqrt{\begin{matrix}\frac{1}{4} {( \frac{{M}_{Mot\_st} * {η}_{ges}}{{J}_{Antr} * {a}_{Anf\_min}} )}^{2} - \\ \frac{{m}_{Fzg} * {a}_{Anf\_min} + {F}_{W}}{{J}_{Antr} * {a}_{Anf\_min}}\end{matrix}}\end{matrix} ) * \frac{{r}_{dyn}}{{i}_{Ha}}$$
in which η_{ges} is an overall efficiency of the motor vehicle, J_{Antr} is a mass moment of inertia of rotating components of the motor vehicle, F_{w} is a driving resistance of the motor vehicle, r_{dyn} is a dynamic tire radius of the drive wheels on the driven axle, and i_{Ha} is a transmission ratio of the axle transmission of the driven axle, and the optimum starting gear (G_{Anf}_{_{—}}ₒₚₜ) is selected as a function of the calculated minimum transmission ratio (i_{Anf}_{_{—}}ₘᵢₙ).

17. The method according to claim 16, further comprising the step of selecting the starting gear (G_{Anf}, G1-G5) as the optimum starting gear (G_{Anf}_{_{—}}ₒₚₜ) depending upon a transmission ratio (i_{G}_{_{—}}_{Anf}, i_{G1}-i_{G5}) which is one of larger than or equal to the calculated minimum transmission ratio (i_{Anf}_{_{—}}ₘᵢₙ)(i_{G}_{_{—}}_{Anf}³≧i_{Anf}_{_{—}}ₘᵢₙ).

18. The method according to claim 16, further comprising the step of selecting the starting gear (G_{Anf}, G1-G5) as the optimum starting gear (G_{Anf}_{_{—}}ₒₚₜ) depending upon a transmission ratio (i_{G}_{_{—}}_{Anf}, i_{G1}-i_{G5}) which is closest to the calculated minimum transmission ratio (i_{Anf}_{_{—}}ₘᵢₙ) (i_{G}_{_{—}}_{Anf}≈i_{Anf}_{_{—}}ₘᵢₙ).

19. The method according to claim 18, further comprising the step of specifying a tolerance limit (δ) above and below the calculated minimum transmission ratio (i_{Anf}_{_{—}}ₘᵢₙ) and, if the transmission ratio (i_{G}_{_{—}}_{Anf}, i_{G1}-i_{G5}) of at least one starting gear (G_{Anf}, G1-G5) is within the tolerance limits, then selecting the starting gear (G_{Anf}, G1-G5), as the optimum starting gear (_{Ganf}_{_{—}}ₒₚₜ), which transmission ratio (i_{G}_{_{—}}_{Anf}, i_{G1}-i_{G5}) is closest to the calculated minimum transmission ratio (i_{Anf}_{_{—}}ₘᵢₙ)(i_{G}_{_{—}}_{Anf}≈i_{Anf}_{_{—}}ₘᵢₙ), whereas if there is no starting gear (G_{Anf}, G1-G5) whose transmission ratio (i_{G}_{_{—}}_{Anf}, i_{G1}-i_{G5}) lies within the tolerance limits (δ), then selecting the starting gear (G_{Anf}, G1-G5), as the optimum starting gear (G_{Anf}_{_{—}}ₒₚₜ), which is the closest lower starting gear (G_{Anf}, G1-G5) whose transmission ratio (i_{G}_{_{—}}_{Anf}, i_{G1}-i_{G5}) is higher than the calculated minimum transmission ratio (i_{Anf}_{_{—}}ₘᵢₙ) (i_{G}_{_{—}}_{Anf i}_{Anf}_{_{—}}ₘᵢₙ).

20. The method according to claim 19, further comprising the step of specifying the tolerance limits (δ) for selecting the optimum starting gear (G_{Anf}_{_{—}}ₒₚₜ) as ±5% relative to the calculated minimum transmission ratio (i_{Anf}_{_{—}}ₘᵢₙ) (δ=i_{Anf}_{_{—}}ₘᵢₙ±5%).

21. The method according to claim 20, further comprising the step of utilizing the highest admissible starting gear (G_{Anf}_{_{—}}ₘₐₓ) as the optimum starting gear (G_{Anf}_{_{—}}ₒₚₜ) (G_{Anf}_{_{—}}ₒₚₜ=G_{Anf}_{_{—}}ₘₐₓ), if there exists a starting gear restriction, when the starting gear (Gᵢ) selected is higher than the highest admissible starting gear (G_{Anf}_{_{—}}ₘₐₓ).

22. The method according to claim 21, further comprising the step of calculating the static engine torque (M_{Mot}_{_{—}}ₛₜ) by multiplying the nominal torque (M_{Mot}_{_{—}}_{Ref}) of the drive engine by a starting factor (f_{Anf}<1).

23. The method according to claim 22, further comprising the step of specifying the starting factor (f_{Anf}) as a constant, independent of the vehicle mass (m_{Fzg}) and of the road gradient (α_{Fb}).

24. The method according to claim 23, further comprising the step of specifying a value for the starting factor (f_{Anf}) as 0.5 (f_{Anf}=0.5).

25. The method according to claim 22, further comprising the step of calculating the starting factor (f_{Anf}) as a variable that is a function of at least one of the vehicle mass (m_{Fzg}) and the road gradient (α_{Fb}).

26. The method according to claim 25, further comprising the step of starting from a standard value (f_{Anf}_{_{—}}_{Std}) valid for at least one of an average vehicle mass (m_{Fzg}_{_{—}}ₘ) and an average road gradient (α_{Fb}_{_{—}}ₘ), at least one of decreasing the starting factor (f_{Anf}) with a decreasing vehicle mass (m_{Fzg}) and increasing the starting factor (f_{Anf}) with an increasing vehicle mass (m_{Fzg}), and decreasing the starting factor (f_{Anf}) with an increasing road gradient (α_{Fb}) and increasing the starting factor (f_{Anf}) with an increasing road gradient (α_{Fb}).

27. The method according to claim 26, further comprising the step of the minimum specifying the starting acceleration (a_{Anf}_{_{—}}ₘᵢₙ) as a constant, independent of the vehicle mass (m_{Fzg}) and the road gradient (α_{Fb}).

28. The method according to claim 27, further comprising the step of specifying the minimum starting acceleration (a_{Anf}_{_{—}}ₘᵢₙ) as a value of 0.2 m/s² (a_{Anf}_{_{—}}ₘᵢₙ=0.2 m/s²).

29. The method according to claim 26, further comprising the step of calculating the minimum starting acceleration (a_{Anf}_{_{—}}ₘᵢₙ) as a variable that is a function of at least one of the vehicle mass (m_{Fzg}) and of the road gradient (α_{Fb}).

30. The method according to claim 29, further comprising the step of starting from a standard value (a_{Anf}_{_{—}}_{Std}) valid for at least one of an average vehicle mass (m_{Fzg}_{_{—}}ₘ) and an average road gradient (α_{Fb}_{_{—}}ₘ), at least one of increasing the minimum starting acceleration (a_{Anf}_{_{—}}ₘᵢₙ) with a decreasing vehicle mass and decreasing the minimum starting acceleration (a_{Anf}_{_{—}}ₘᵢₙ) with increasing vehicle mass (m_{Fzg}), and increases the minimum starting acceleration (a_{Anf}_{_{—}}ₘᵢₙ) with a decreasing road gradient (α_{Fb}) and decreasing the minimum starting acceleration (a_{Anf}_{_{—}}ₘᵢₙ) with an increasing road gradient (α_{Fb}).
